(19) United States
(12) Patent Application Publication
(10) Pub. No.: US 2013/0320688 A1
(43) Pub. Date: Dec. 5, 2013

(54) Bariatric Adapter for Standard-Size Gurney

(71) Applicants: Larry D. HORNADAY, Clackamas, OR (US); Joshua J. Sharp, Portland, OR (US)

(72) Inventors: Larry D. HORNADAY, Clackamas, OR (US); Joshua J. Sharp, Portland, OR (US)

(21) Appl. No.: 13/486,409

(22) Filed: Jun. 1, 2012

(51) Int. Cl. A61G 1/02; B23P 17/04

(52) U.S. Cl. 296/20; 29/401.1

(57) ABSTRACT

A bariatric adapter for a portable patient-transport gurney provides a wider, secure and comfortable surface for carrying larger patients. The adapter may be constructed in multiple segments so that adjustments of the gurney (e.g., elevating head/torso support or leg supports) can still be used. The adapter does not require modifications to the gurney, so it can be removed when not needed. However, smaller patients may also find the wider bed more comfortable, so it may be left attached for all users.

### CONTINUITY AND CLAIM OF PRIORITY

This is an original U.S. patent application.

### FIELD

The invention relates to medical transportation equipment. More specifically, the invention relates to adapters to extend the bariatric-patient carrying capacity of existing stretchers, cots and gurneys, and to improve the comfort of all patients being transported.

### BACKGROUND

Equipment for transporting injured, sick or disabled people is subject to a variety of design constraints that are often in conflict. For example, a patient's injury may be exacerbated if the patient cannot be held securely in a particular position or orientation, but the adjustability to permit such secure transport may make the equipment heavy or bulky, so that it cannot be maneuvered from place to place, or may require a larger team of attendants to operate and move it. Imposing the further requirements that the equipment be rugged, relatively lightweight, and that it not occupy an excessive proportion of the limited space available in an emergency vehicle, results in serviceable but constrained designs.

One challenge emergency medical responders are encountering more frequently is that of dealing with larger patients (regardless of whether those patients meet the medical definition of obesity). The portable gurneys used to carry patients to and from an ambulance may have service weight limits of 700 pounds (318 kg), but a typical gurney is only 23 inches (58 cm) wide—much too narrow to carry a 500 pound (230 kg) patient, even though such a patient would not exceed the weight limit. The alternative is to deploy a special bariatric-patient gurney, but these contraptions are much more expensive, heavier, and often must be used with ramp and winch systems, which embarrass and humiliate the patient by treating him as a “wide load” to be yarded around with heavy equipment.

An adapter to improve the bariatric-patient handling capacity of a standard gurney may extend the usefulness of such a gurney, and do so without requiring permanent modifications thereto. In addition, features to suit the adapter to use in an ambulance or medical services van may allow an ordinary EMS vehicle and crew to serve a wider range of patient sizes with care, comfort, security and dignity.

### SUMMARY

Embodiments of the invention enlarge the horizontal carrying surfaces of a portable gurney (cot, stretcher) to accommodate larger patients (those whose weight is below the service limit of the gurney, but whose bulk makes use of the gurney alone unstable or uncomfortable). Features of the invention allow it to be attached to the gurney when needed (and removed when not needed) so that the gurney's normal configuration and function are not affected. Furthermore, an embodiment may be stored securely when not in use, without consuming excessive space in an ambulance or other emergency-services vehicle.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a simplified gurney with an embodiment of the invention partially installed thereon.

FIG. 2 shows a top perspective view of a sample embodiment of the invention.

FIG. 3 shows a bottom perspective view of the sample embodiment of the invention.

FIG. 4 is a perspective view of an anti-shift peg (shown inverted from its usual position).

FIG. 5 is a cross-section view of an anti-shift peg, also showing a portion of the box section of an embodiment and a portion of the patient-support surface of a standard gurney.

FIG. 6 is an exploded view of one segment of an embodiment.

FIG. 7 shows a mounting panel for attaching an embodiment to an EMS vehicle when not in use.

FIG. 8 is a flow chart outlining a method for preparing an embodiment of the invention for use.

FIG. 9 shows a cross section of bolsters and mattress pad.

### DETAILED DESCRIPTION

Embodiments of the invention are planar adapters that increase the size (surface area) of the patient bed of a portable gurney. The adapters are designed to work with popular EMS (“Emergency Medical Services”) equipment and to improve the security and comfort of larger patients being transported on such a gurney. In addition, the adapters have features that improve their function and utility in the context of emergency-response medical service.

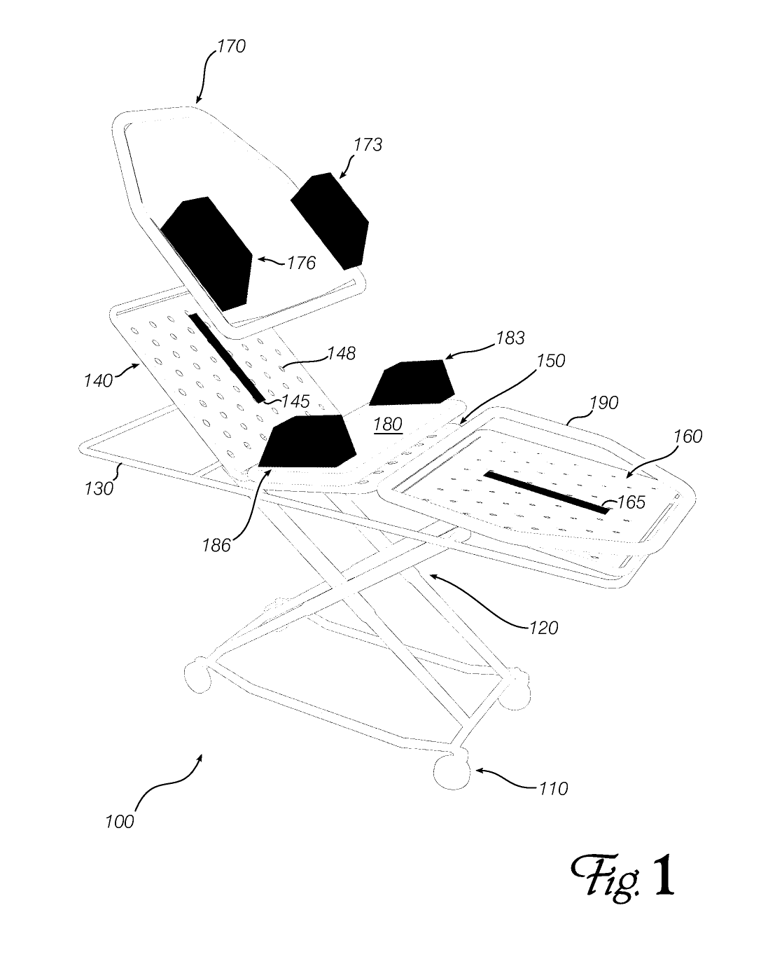

FIG. 1 is a simplified overview drawing showing a sample standard gurney 100, comprising inter alia a wheeled frame 110, a scissor-action mechanism 120 for raising and lowering the patient, a frame 130 and three adjustable segments: head support 140, abdomen support 150 (mostly obscured in this view) and leg support 160. Hook-and-loop fasteners are visible on head and leg supports at 145 and 165; in use, a padded mattress would normally be placed on the supports and secured with these fasteners. Note that the patient-support surfaces of this standard gurney have regular perforations (e.g., 148) to reduce weight and improve air circulation.

An actual gurney would be somewhat more complex than this figure suggests: it may have power or hydraulic lifts, wheel locks, IV stand supports, or other features that are not of consequence to embodiments of the invention.

FIG. 1 also shows an embodiment of the invention, including a head/torso support section 170, an abdomen support section 180 and a portion of a lower-extremity support section 190. Head/torso support section 170 is shown displaced vertically from its normal installed position, while abdomen support section 180 is shown installed, and lower-extremity support 190 is installed, but several subcomponents are omitted in this view to allow the following points to be observed:

First, the sections of an embodiment are generally wider than the corresponding patient support surfaces of the standard gurney. For example, a standard gurney may be roughly rectangular, with a width of approximately 23 inches (58 cm) and a length (fully extended) of approximately 80 inches (203 cm). Embodiments may be somewhat wider, at perhaps 26 inches (66 cm), up to perhaps 36 inches (91 cm). A wider surface is preferable from a patient comfort perspective, but the gurney and attachment must still pass easily through standard doors. For this reason, a width less than the common door width of 30 inches (76 cm) is preferred.

However, note that the upper and lower ends of the embodiment are tapered, and may be no wider than (or even narrower than) the standard gurney at the ends. Extra width at these locations contributes little to patient comfort, while the tapers may significantly improve the maneuverability of the gurney around corners and through doorways. The overall length of an embodiment may be approximately the same as the length of the standard gurney for which it is designed.

FIG. 1 also shows several of the side bolsters that are present in an embodiment (173, 176, 183 and 186). These bolsters may be made of a firm, resilient material such as a dense polyurethane foam, preferably covered by a tough, waterproof material such as a marine-grade vinyl.

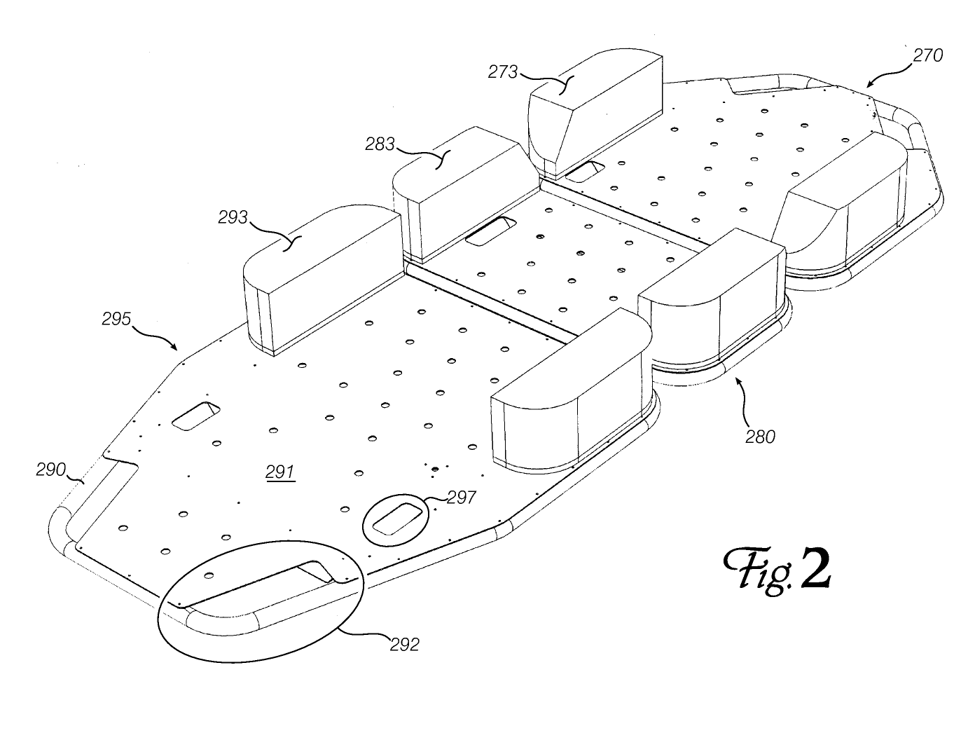

FIG. 2 is a top perspective view of a representative embodiment of the invention. This embodiment includes three independent segments: a head/torso support segment 270, an abdomen support segment 280, and a lower-extremity support segment 295. Each segment is constructed similarly, with an upper support sheet (e.g. 291) of a material such as aluminum, steel or plastic plate; secured to a tubular frame (e.g. 290) that surrounds and substantially follows the perimeter of the upper support sheet. Each segment has pads or bolsters 273, 283, 293 at each lateral side, oriented lengthwise along the patient support surface. The head/torso segment 270 and lower-extremity segment 295 include portions (e.g., 292) where the top sheet is cut away from the tubular frame, exposing the frame to be used as a hand-hold for steering the gurney. In addition, each segment has an opening (e.g., 297) in the top patient-support surface through which a securing belt (attached to the standard gurney below) may be passed.

The embodiments of FIGS. 1 and 2 are constructed in three separate sections because the standard gurney for which they are designed has independently-adjustable head and foot sections. (A center section is also present on some standard gurneys; this section may also be adjustable.) The head section may be raised to allow the patient to sit up, or the foot may be raised to help improve patient circulation and/or increase blood pressure. By constructing the bariatric adapter in corresponding sections, each section can be attached to its corresponding segment of the standard gurney, and the standard gurney's adjustment features will still function normally. A simpler embodiment consisting of a single segment, but constructed similarly to what is described below, may be less expensive to make, but is less useful (it may prevent adjustments that the standard gurney is capable of, and may be less convenient to store when not in use).

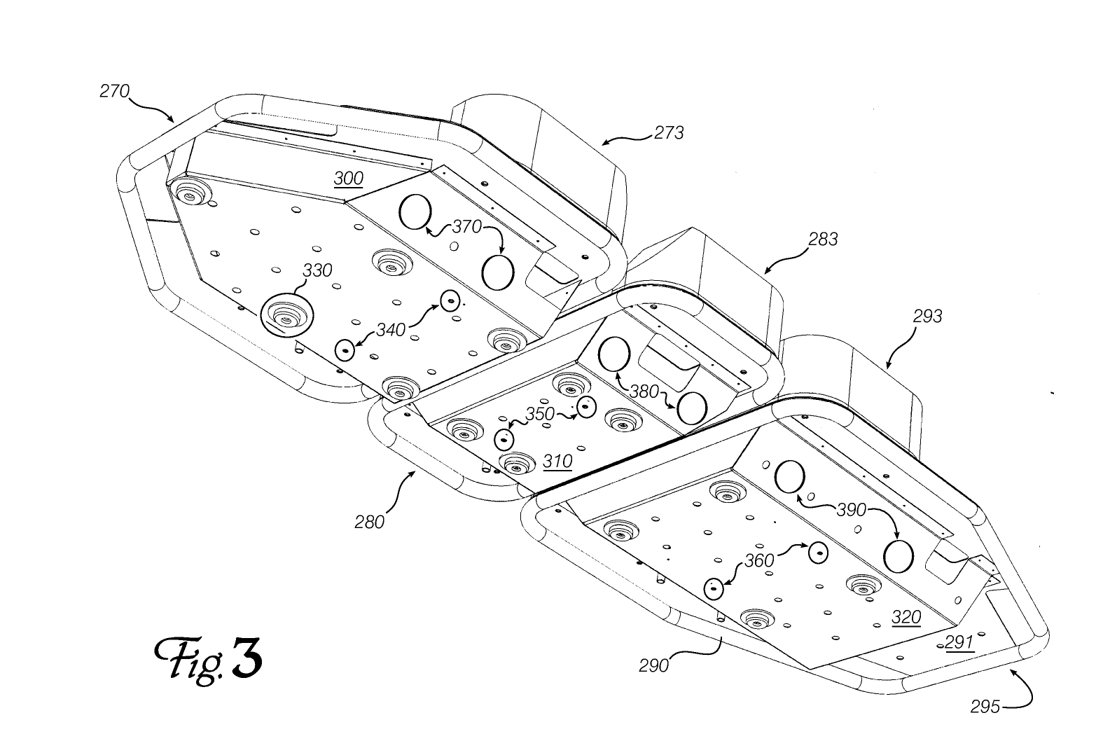

FIG. 3 is a lower perspective view of the embodiment of FIG. 2. The three sections 270, 280, 295 are visible, as are the side bolsters 273, 283, 293, tubular frame 290 and portions of the underside of the upper support sheet 291. However, this view is dominated by the three box-section support structures 300, 310 and 320, which are attached to the corresponding tubular frames and top sheets. The box-section supports provide strength and rigidity to each segment, allowing the segment to support a portion of the patient's weight and to transmit the force effectively to the standard gurney below. The box sections may be made from folded and welded sheet metal material such as aluminum or steel, molded from a suitable polymer, or laid up from a fiberglass or carbon-fiber material. The choice between these materials may be made based on availability, durability, price, weight, and other considerations, in the exercise of ordinary engineering judgment.

Each segment of the bariatric adapter is designed to rest upon a corresponding portion of the standard gurney. However, it is essential that the adapter not shift or slide relative to the gurney surface, lest the gurney tip over or the patient be dropped. Embodiments of the invention resist shifting or sliding by using anti-shift features that are visible in FIG. 3: each of the circular posts or pegs (one of which is circled at 330) is positioned so as to mate with a depression or hole in the upper surface of the standard gurney. When so mated, the pegs resist shifting forces, which are experienced locally as shear stresses.

Some embodiments may include openings on the angled sides of the box-section supports, as shown at 370, 380 and 390. The purpose of these openings will be discussed below.

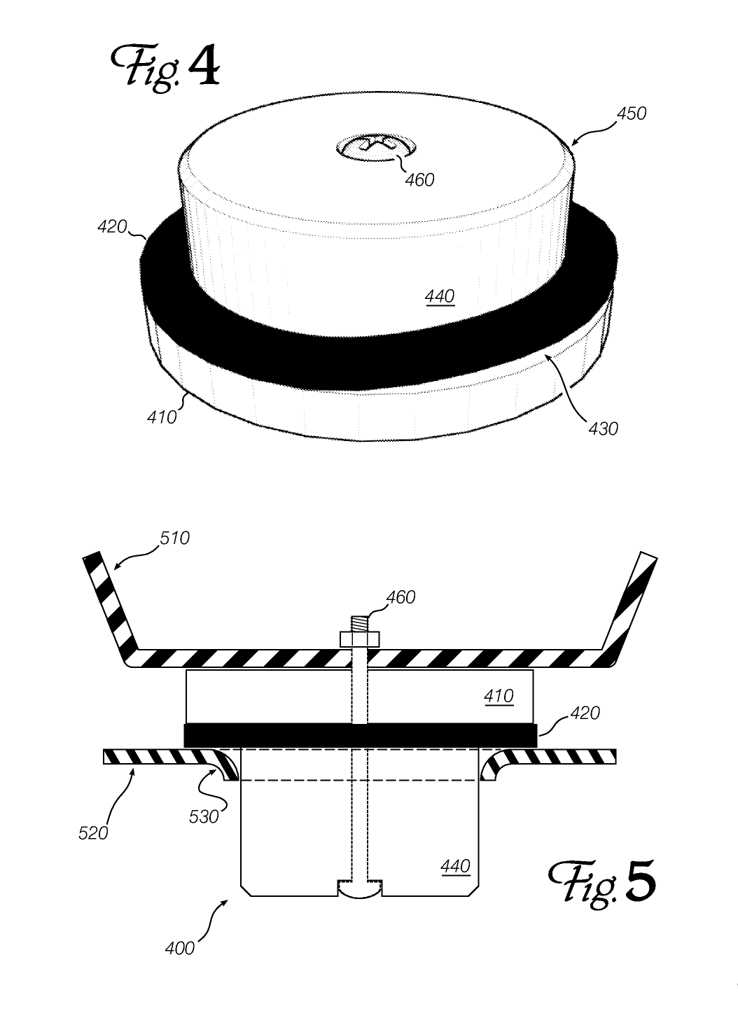

FIG. 4 is a detail view of one implementation of anti-shift peg. This figure shows the peg upside clown from its normal orientation on the underside of a box section support. The peg is generally cylindrical, with a largest-diameter portion 410 that spreads compression and torque forces over a larger area of the box section. Each adapter section is spaced apart from the underlying gurney surface by approximately the thickness of 410 and a resilient flange or washer 420. Flange 420 may be made of a material like rubber or neoprene, and may be sandwiched between 410 and 440, or may simply rest upon 410 (reference character 430 shows that it may be possible to lift flange 420 off the lower ledge, for example, to replace the flange. The resilient material provides padding between the lower surface of an embodiment and the upper surface of the standard gurney, to accommodate slight misalignments between the two surfaces, and to prevent excessive wear on the gurney upper surface clue to concentration of forces around the anti-shift pegs.

A smaller-diameter portion 440 forms the peg that mates with a corresponding hole or depression in the standard gurney patient-carrying surface, and bears any shear forces that act to slide the adapter segment horizontally across the gurney surface. A tapered or beveled end portion 450 makes it easier to align the adapter segment with the holes or depressions in the gurney surface; and if the gurney has depressions (rather than holes), the bevel may allow secure, complete seating despite debris that may be in the gurney depression. A screw or bolt 460 may be used to secure the anti-shift peg to the bottom of the box-section support, as discussed below.

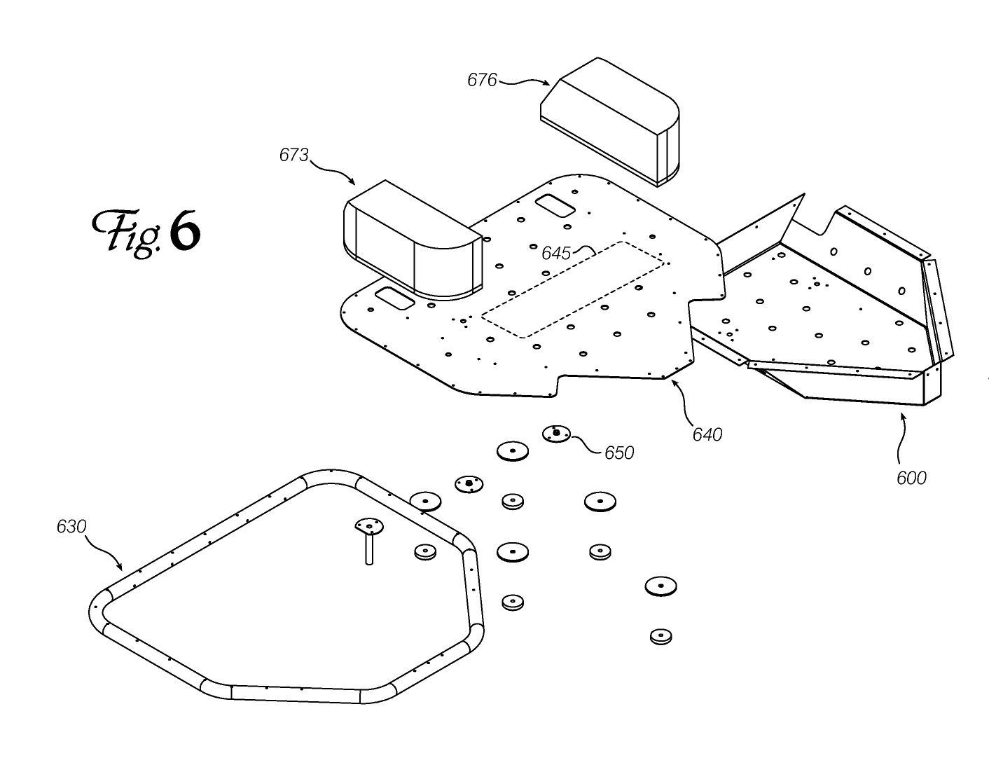

FIG. 5 shows a cross-section of an anti-shift peg (generally 400) attached to a box-section support (cross section 510) by screw or bolt 460. The differing diameters of the peg 410 and pad 420 are visible here, and it can be seen that box-section support 510 is spaced apart from the patient-carrying surface of the gurney, 520, by the thickness of 410 and 420. Holes in the patient carrying surface of the gurney often have formed, radiused edges as shown at 530 to increase the strength of the surface.

Referring again to FIG. 3, note that this embodiment has two threaded receptacles (340, 350, 360) in each box section support to accept a screw inserted from below the standard gurney surface. The screws (which preferably have large, finger-operable knobs on their ends) hold the adapter against the standard gurney surface, keeping the anti-shift pegs engaged in their corresponding holes. Other embodiments may use a solid rod extending from the bottom of the adapter, through the standard gurney upper surface and secured by a hairpin cotter clip or “R-clip,” or a pivoting claw-type latch that grasps a frame rail of the standard gurney.

Note that the lower box-section support raises the bariatric adapter frame above the surface of the standard gurney by approximately the height of the box section (plus, inter alia, the thickness of the largest-diameter portion of the anti-shift peg and the rubber flange or washer, as discussed above). The box section height is preferably chosen so that the tubular frame of the adapter rests upon frame rails or hand rails of the standard gurney, to distribute the weight of the patient more effectively across the support surfaces of the gurney.

FIG. 6 is an exploded view of the head/torso section of an embodiment of the invention. This view shows the tubular segment frame 630, top support sheet 640, box-section lower support 600, and side bolsters 673 and 676. The top sheet, frame and lower support may be joined together by welds, adhesive, or rivets (as suggested by the holes shown in this figure). Several disassembled anti-shift pegs are visible, and a threaded T-nut (or flanged nut) structure identified at 650 may be attached to the box-section lower support to accept the releasable engagement screws that hold the segment to the corresponding portion of the gurney. Note that the box section support, when covered by the top sheet, forms a hollow compartment. A door or covering 645 may be provided in the top sheet to access this compartment. This may provide useful storage for adapter accessories, such as patient safety belt extensions or extra securing screws.

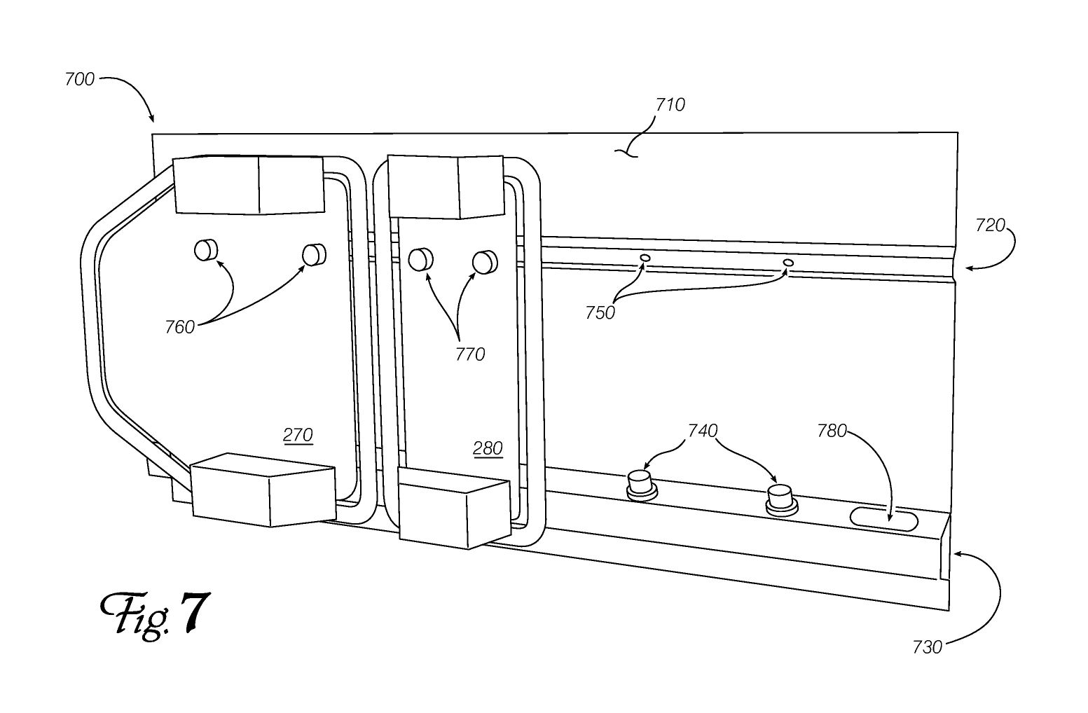

FIG. 7 shows a mounting panel that may be supplied with an embodiment to facilitate storage of the embodiment segments on a side wall of an ambulance or EMS vehicle when the embodiment is not in use. Segments of an embodiment can be hung against the wall where they take up little space and do not interfere with patient-care activities inside the vehicle.

The hanger (generally 700) is a mostly-planar sheet 710 with two horizontal channels 720 and 730 raised above its surface. Upper channel 720 may be smaller, since it only needs to provide relief for threaded fasteners (nuts, etc.) installed behind sheet 710. Lower channel 730 extends further out from the base plane, and mounting features similar to (or in some embodiments, identical to) the anti-shift features on a patient support segment are attached to its upper surface (740). These mounting pegs mate with corresponding holes in the box-section support of a segment (see, e.g., FIG. 3: 370, 380 and 390), and provide vertical support for the segment. Horizontal support to keep each segment from falling off the hanger may be provided by bolts or similar fasteners, which may be secured to the threaded fasteners at 750. In this figure, two patient support segments 270 and 280 are shown in place, and held against the hanger by finger-manipulable fasteners 760 and 770. Since the lower channel 730 extends further out from the mounting plane, an embodiment may use the space in the channel for storage, by providing an opening or door 780.

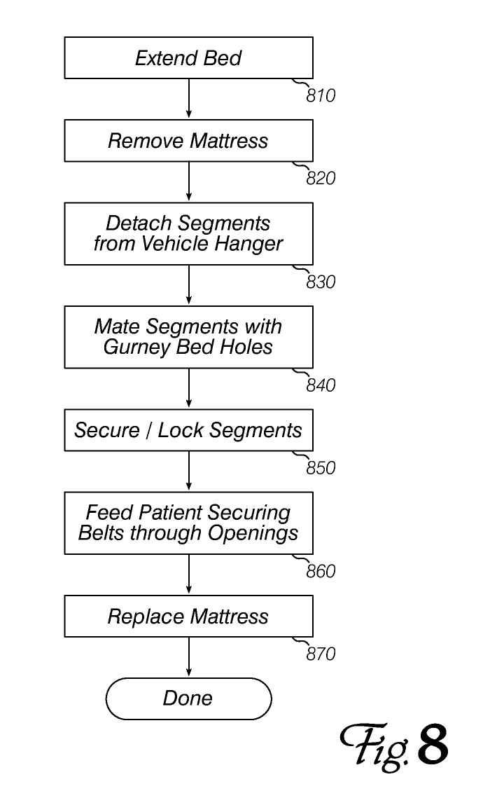

FIG. 8 outlines steps involved in preparing an embodiment for use. To transport a large patient, the attendants may extend or flatten the bed of the standard gurney (810) and remove the mattress pad (typically by disengaging hook-and-loop fasteners) (820). Next, segments of the embodiment are disengaged from the carrier or mounting brackets (830), and each segment is mated to its corresponding gurney section by inserting the anti-shift pegs into the depressions or holes (840). Then, the segments are secured in place by engaging the threaded fasteners, inserting R-clips, latching the pivoting-claw latches, or activating such other locking mechanisms as may be provided with the embodiment (850). Now, patient-securing belts are fed through the openings in the embodiment segments, so that the patient can be strapped in if necessary (860). Finally, the mattress pad is replaced on top of the segments of the embodiment (870). Note that because the patient-carrying surfaces of an embodiment are displaced slightly from the surfaces of the standard gurney, they will move differently when the head and/or foot sections are adjusted. For this reason, it is preferable to secure the mattress pad on only one end (otherwise, the pad may crease or bunch up). Preferably, an embodiment has a hook-and-loop fastener only on the lower-extremity support segment; the middle and upper end of the mattress pad is left free to slide up as the head/torso support section is adjusted.

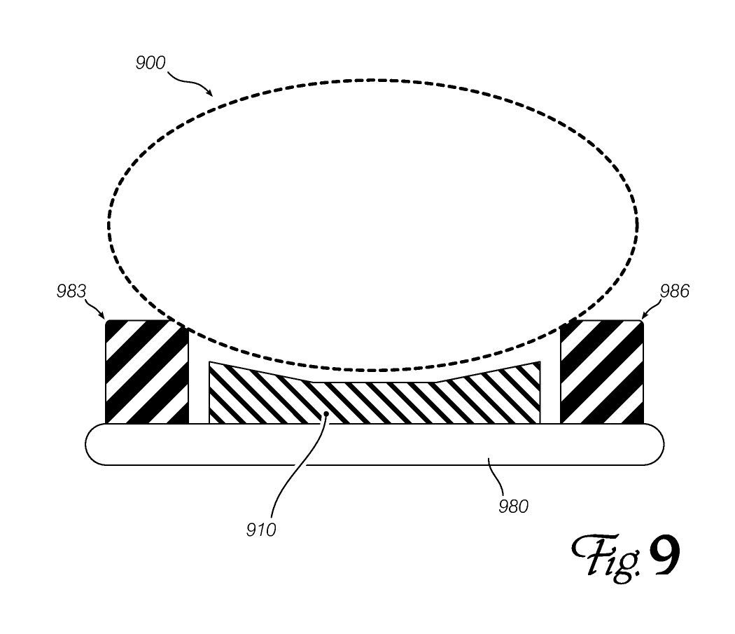

FIG. 9 is a cross-section showing a preferred relationship between the bolsters 983, 986 of an embodiment and the mattress pad 910 of a standard gurney, placed over the surface of an embodiment as discussed with reference to FIG. 8. Even if a patient's body (represented here by oval 900) is wider than the mattress and bolsters, the higher profile and firmer construction of the bolsters provides a significantly improved feeling of security for the patient. Patients who report feeling like they may roll or slide off a standard gurney (even though, statistically speaking, that is unlikely) prefer being transported on a cot equipped with an embodiment of the invention.

Features and design details of the present invention have been described largely by reference to specific examples and in terms of particular implementations. However, those of skill in the art will recognize that improved bariatric-patient transport capabilities can also be achieved by adapter designs that implement the goals described differently than the reference embodiments discussed. Such variations and alternate designs are understood to be captured according to the following claims.

We claim:

1. A bariatric patient adapter for a standard gurney, comprising:
a patient-support surface that is wider than a corresponding surface of the of the standard gurney along a majority of a length of the surface;
side bolsters near outside lateral edges of the patient support surface and oriented lengthwise along the patient support surface;
anti-shift features to prevent the patient support surface from sliding relative to the corresponding surface of the standard gurney; and
a releasable engagement mechanism for preventing disengagement of the anti-shift features.

2. The bariatric patient adapter of claim 1, wherein the patient support surface is divided across its width into a plurality of shorter segments, each shorter segment having its own side bolsters, anti-shift features and releasable engagement mechanism.

3. The bariatric patient adapter of claim 2 wherein the plurality of shorter segments is three shorter segments.

4. The bariatric patient adapter of claim 1 wherein the anti-shift features are pegs positioned to mate with corresponding holes in the corresponding surface of the standard gurney.

5. The bariatric patient adapter of claim 4 wherein the pegs comprise a post of a first diameter, and a resilient flange of a second, larger diameter, and a rigid flange of a diameter approximately equal to the second larger diameter.

6. The bariatric patient adapter of claim 1, wherein the patient support surface comprises at least one pair of openings to permit a patient-securing belt attached at each end to the standard gurney, to pass through the patient support surface, around a patient upon the patient support surface, and back through the patient support surface.

7. The bariatric patient adapter of claim 1 wherein the releasable engagement mechanism is a threaded coupler.

8. The bariatric patient adapter of claim 1 wherein the releasable engagement mechanism is a pin with an R-clip.

9. The bariatric patient adapter of claim 1 wherein the releasable engagement mechanism is a pivoting-claw latch.

10. The bariatric patient adapter of claim 1 wherein the patient support surface comprises:
an upper support sheet;
a tubular frame secured to and substantially following a perimeter of the upper support sheet; and
a lower box-section support attached to at least one of the upper support sheet and the tubular frame, and wherein
the anti-shift features are secured to the lower box-section support.

11. The bariatric patient adapter of claim 10 wherein a height of the lower box-section support raises the adapter above the surface of the standard gurney so that the tubular frame rests on side rails of the standard gurney.

12. The bariatric patient adapter of claim 10, further comprising:
a covered storage compartment between the upper support sheet and the lower box-section support.

13. A method for reconfiguring a standard gurney to transport an obese patient with improved security and comfort, comprising:
detaching a plurality of separate patient-support segments from a carrier affixed to an emergency vehicle;
removing a mattress pad covering a top surface of the standard gurney;
attaching the plurality of separate patient-support segments to corresponding independently-adjustable segments of the top surface, each patient-support segment having a width exceeding a width of the corresponding independently-adjustable segment; and
replacing the mattress pad to cover a portion of the plurality of separate patient support segments.

14. The method of claim 13, further comprising:
passing safety belts that are attached on one end to the standard gurney, through openings in the patient support segments so that the safety belts may be buckled across a patient resting on the patient support segments.

15. The method of claim 13 wherein attaching comprises:
engaging anti-shift features of each of the plurality of separate patient support segments with corresponding features of the independently-adjustable segments of the top surface; and
securing at least one reversible fastener of each patient support segment to the corresponding independently-adjustable segment.

16. The method of claim 15 wherein the anti-shift features are a plurality of posts on a lower surface of each patient support segment and the corresponding features are a plurality of holes in the independently-adjustable segments of the top surface; and
wherein the at least one reversible fastener is a threaded coupler.

17. A bariatric patient adapter for a standard gurney, comprising:
a head and torso support section;
an abdomen support section; and
a lower extremity support section,
each support section constructed of an upper surface plate surrounded by a tubular circumferential frame, said frame in turn supported by a box-section lower support,
each box-section lower support having a plurality of pegs positioned to mate with a corresponding plurality of openings in an upper surface of a standard gurney bed, said pegs functional to prevent in-plane displacement between the support section of the bariatric patient adapter and the upper surface of the standard gurney bed,
each support section having at least one tensioning device to prevent the support section from being lifted off the upper surface of the standard gurney bed when the tensioning device is engaged, and
each support section having bolsters at each lateral side thereof.

18. The bariatric patient adapter of claim 17, further comprising:
a hook-and-loop securing strip on the lower-extremity support section, said securing strip to attach to an underside of a mattress pad to prevent the pad from sliding off the support sections.

19. The bariatric patient adapter of claim 18 wherein the lateral side bolsters comprise a compressible foam core covered by a waterproof vinyl shell, said compressible foam core being firmer and less compressible than a foam core of the mattress pad.
